(19) United States
(12) Patent Application Publication
(10) Pub. No.: US 2015/0352606 A1
(43) Pub. Date: Dec. 10, 2015

(54) COATING FILM REMOVING APPARATUS

(71) Applicant: Toppan Printing Co., Ltd., Taito-ku (JP)

(72) Inventor: Yuji KUBO, Taito-ku (JP)

(73) Assignee: Toppan Printing Co., Ltd., Taito-ku (JP)

(21) Appl. No.: 14/831,110

(22) Filed: Aug. 20, 2015

Related U.S. Application Data
(63) Continuation of application No. PCT/JP2014/000792, filed on Feb. 17, 2014.

(30) Foreign Application Priority Data
Feb. 21, 2013 (JP) 2013-032582
Sep. 24, 2013 (JP) 2013-196929

(51) Int. Cl. B08B 3/12; B08B 5/02; B08B 3/02

(52) U.S. Cl. CPC B08B 3/12; B08B 3/024; B08B 5/02

(57) ABSTRACT

A coating film removing apparatus includes a removal liquid supply device which has a discharge port and discharges removal liquid through the discharge port such that the removal liquid for removing a coating film on a substrate is discharged only to a coating film removal portion of the coating film, and a removal liquid recovery device which has a recovery port and recovers the removal liquid through the recovery port. The removal liquid supply device discharges a predetermined quantity of the removal liquid to the coating film removal portion in a state where the discharge port and the recovery port are positioned to face the coating film removal portion such that the removal liquid discharged through the discharge port is recovered through the recovery port.

### CROSS-REFERENCE TO RELATED APPLICATIONS

The present application is a continuation of International Application No. PCT/JP2014/000792, filed Feb. 17, 2014, which is based upon and claims the benefits of priority to Japanese Application No. 2013-032582, filed Feb. 21, 2013 and Japanese Application No. 2013-196929, filed Sep. 24, 2013. The entire contents of all of the above applications are incorporated herein by reference.

### BACKGROUND OF THE INVENTION

1. Field of the Invention

The present invention relates to a coating film removing apparatus that selectively removes a coating film in a manufacturing process such as of a polymer organic EL display panel.

2. Discussion of the Background

In an organic EL device, a voltage is applied to an electrically conductive organic light-emitting medium layer to recombine an injected electron and a hole and, in the recombination, an organic light-emitting material is made luminous, the material configuring an organic light-emitting layer included in the organic light-emitting medium layer. The organic light-emitting medium layer is provided with a first electrode and a second electrode on both sides thereof to apply a voltage to the organic light-emitting layer and externally emit light.

The organic EL device is configured by sequentially laminating a first electrode, an organic light-emitting layer and a second electrode (counter electrode) on a transparent substrate. Normally, the first electrode formed on the substrate is used as an anode, and the counter electrode formed on the organic light-emitting layer is used as a cathode.

Further, for the purpose such as of increasing light-emitting efficiency, in many cases, a hole transport layer and a hole injection layer are appropriately selected and provided between the anode and the organic light-emitting layer, or an electron transport layer and an electron injection layer are appropriately selected and provided between the organic light-emitting layer and the cathode to provide a configuration as an organic EL device. A laminated structure in which the organic light-emitting layer is joined to a hole transport layer, a hole injection layer, an electron transport layer and an electron injection layer is called an organic light-emitting medium layer.

Materials that configure and function as the organic light-emitting medium layer (light-emitting medium materials) are usually low molecular-weight compounds. Layers, each having a thickness of not less than around 1 nm to not more than around 100 nm, are laminated by vacuum vapor deposition, such as resistive heating. Accordingly, manufacture of an organic thin film EL device using low-molecular materials involves use of a vacuum deposition apparatus in which a plurality of deposition furnaces are connected. This creates a problem such as of lowering productivity and raising manufacturing cost.

In this regard, there is a polymer EL device that uses a polymeric material as an organic light-emitting medium layer.

There can be used, as the light-emitting medium layer, materials each obtained by dissolving a low molecular-weight light-emitting dye into a polymer, such as polystyrene, polymethyl methacrylate or polyvinyl carbazole, or polymeric luminescent materials, such as a poly-phenylene vinylene derivative (PPV) or a poly alkyl fluorene derivative (PAF). These polymeric materials can be dissolved or dispersed into a solvent, for formation of a coating film by means of a wet method, such as a coating method or a printing method. Accordingly, compared to the organic EL devices that use low-molecular materials mentioned above, polymeric materials enable film formation under atmospheric pressure and thus have an advantage of lowering equipment cost.

The wet method, e.g. the coating method, includes a spin coating method, a bar coating method, a slit coating method or a dip coating method. When patterning of particularly high precision is unnecessary, this coating method, which enables easy and uniform film formation, is effective. Thus, the coating method is effective in forming a film of a common layer, such as the hole transport layer or the hole injection layer, which is not required to be color coded on a pixel basis.

On the other hand, when high-precision patterning or RGB three-color-coding is unnecessary, the most effective thin-film formation method is the printing method, such as an intaglio printing method, relief printing method, planographic printing method, screen printing method or ink-jetting method.

Hereinafter will be described sealing that is a process after forming a cathode on a lamination of the organic light-emitting medium layer.

An organic light-emitting medium layer, when it is left with a cathode being formed thereon, is likely to be particularly affected by moisture (water vapor) or oxygen. Because of this, the light-emitting effect may be lowered or the metal electrodes may be deteriorated, causing a non-luminous defect which is called a dark spot. Therefore, generally, an organic light-emitting medium layer formed with a cathode thereon is sealed with a sealing glass substrate in a chamber where moisture and oxygen are suppressed to the utmost, the glass substrate having a portion facing a display area with an absorbent being arranged in the facing portion.

When a sealing glass substrate is formed on a substrate where an organic light-emitting medium layer is formed, a predetermined adhering width (sealing space) is needed for the adherence of the sealing glass substrate to the substrate where the organic light-emitting medium layer is formed. In this case, it is desirable that the organic materials configuring the organic light-emitting medium layer are not applied to the sealing space in order that sufficient sealing performance is obtained. However, when the hole transport layer and the hole injection layer are formed by the coating method, films of the organic materials may be formed extended into the sealing space, which raises a problem of impairing the sealing performance.

As a measure against this, there is a proposal that a printing method is used for forming the hole transport layer and the hole injection layer, which can dispense with patterning, thereby forming films only in a necessary range.

Further, as a method of removing a film that has been formed in a film formation unneeded region, there is also proposed, for example, a method of removing unnecessary film by immersing a portion, where the unnecessary film is coated (e.g., an end portion of a substrate), into a reservoir where a solvent for removing the film is stored (e.g., see Patent Literatures 1 and 2).

Patent Literature 1: JP-A-H08-102434

Patent Literature 2: JP-A-H11-143088

### SUMMARY OF THE INVENTION

According to one aspect of the present invention, a coating film removing apparatus includes a removal liquid supply device which has a discharge port and discharges removal liquid through the discharge port such that the removal liquid for removing a coating film on a substrate is discharged only to a coating film removal portion of the coating film, and a removal liquid recovery device which has a recovery port and recovers the removal liquid through the recovery port. The removal liquid supply device discharges a predetermined quantity of the removal liquid to the coating film removal portion in a state where the discharge port and the recovery port are positioned to face the coating film removal portion such that the removal liquid discharged through the discharge port is recovered through the recovery port.

According to another aspect of the present invention, a coating film removing apparatus includes a removal liquid supply device which has a discharge port and discharges removal liquid through the discharge port such that the removal liquid for removing a coating film on a substrate is discharged only to a coating film removal portion of the coating film, a removal liquid recovery device which has a recovery port and recovers the removal liquid through the recovery port after lapse of a predetermined time from discharge of the removal liquid by the removal liquid supply device, and a gas supply device which has a gas discharge port and discharges a gas through the gas discharge port such that the removal liquid remains in the coating film removal portion during a period from start of discharge of the removal liquid by the removal liquid supply device until completion of recovery of the removal liquid by the removal liquid recovery device. The gas discharge port is formed outside the discharge and recovery ports for the removal liquid, and the discharge and recovery ports for the removal liquid and the gas discharge port are formed in a horizontal movement section which is horizontally movable.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIGS. 1(a)-1(c) show plan views illustrating an example of a configuration of a coating film removing apparatus related to an embodiment of the present invention, with FIG. 1(a) showing a state where film formation unneeded regions in a longitudinal direction are being treated, with FIG. 1(b) showing a state where the film formation unneeded regions in a lateral direction are being treated, and with FIG. 1(c) showing a state where removal of the coating film has been completed in all the film formation unneeded regions;

FIG. 2 is a perspective view illustrating an example of an operation of a coating film removing apparatus related to the embodiment of the present invention;

FIG. 3 is a cross-sectional view illustrating a removal treatment unit according to a first embodiment of the present invention, the cross-sectional view being taken along A-A of FIG. 1(c);

FIG. 4 is a cross-sectional view illustrating an example of a coating film removal means having an ultrasonic oscillation application means, related to the first embodiment of the present invention;

FIG. 5 is a configurational view illustrating another example of the coating film removing apparatus;

FIG. 6 is an explanatory view for explaining operation of the coating film removing apparatus illustrated in FIG. 5;

FIG. 7 is a cross-sectional view illustrating a removal treatment unit related to a second embodiment of the present invention, the cross-sectional view being taken along A-A of FIG. 1(c); and

FIG. 8 is a cross-sectional view illustrating an example of a coating film removal means having an ultrasonic oscillation application means, related to the second embodiment of the present invention.

### DESCRIPTION OF THE EMBODIMENTS

With reference to the drawings, hereinafter are described a coating film removing apparatus related to each embodiment of the present invention. It should be noted that, in the drawings, parts having the same function with the same configuration are assigned with the same references.

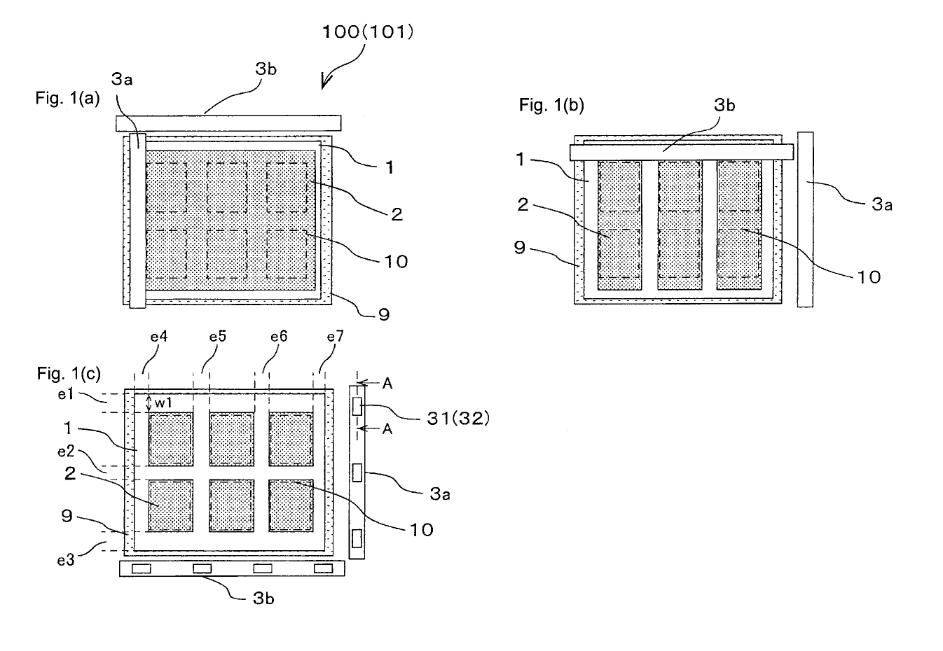

FIGS. 1(a)-1(c) are schematic configurational views illustrating an example of a coating film removing apparatus 100 or 101 to which the present invention is applied. The coating film removing apparatus 100 or 101 is an apparatus for removing coating film removal portions which are parts of a coating film on a substrate. In other words, the apparatus removes coating film removal portions that are coated in film formation unneeded regions where coating of the coating film is unneeded.

### First Embodiment

(Configuration)

In FIGS. 1(a)-1(c), a reference 1 indicates a substrate that is a target of removing a coating film. Reference 2 indicates a coating film coated on the substrate 1. Reference 10 indicates needed film formation regions on the substrate 1 in the coating film 2 coated on the substrate 1. Coating film portions other than the needed film formation regions 10 correspond to the film formation unneeded regions in which the respective coating film removal portions are located.

The coating film removing apparatus 100 related to the first embodiment of the present invention includes a coating film removal means 3 and a stage 9 that adsorbs and holds the substrate 1 that is a target of removing a coating film. The coating film removal means 3 includes a coating film removal means (longitudinal) 3a that moves along a right-and-left direction of the stage 9 in FIGS. 1(a)-1(c) to remove a coating film on a longitudinal-direction (up-and-down direction in FIGS. 1(a)-1(c)) unit basis relative to the substrate 1, and a coating film removal means (lateral) 3b that moves in an up-and-down direction of the stage 9 in FIGS. 1(a)-1(c) to remove the coating film on a lateral-direction unit basis relative to the substrate 1.

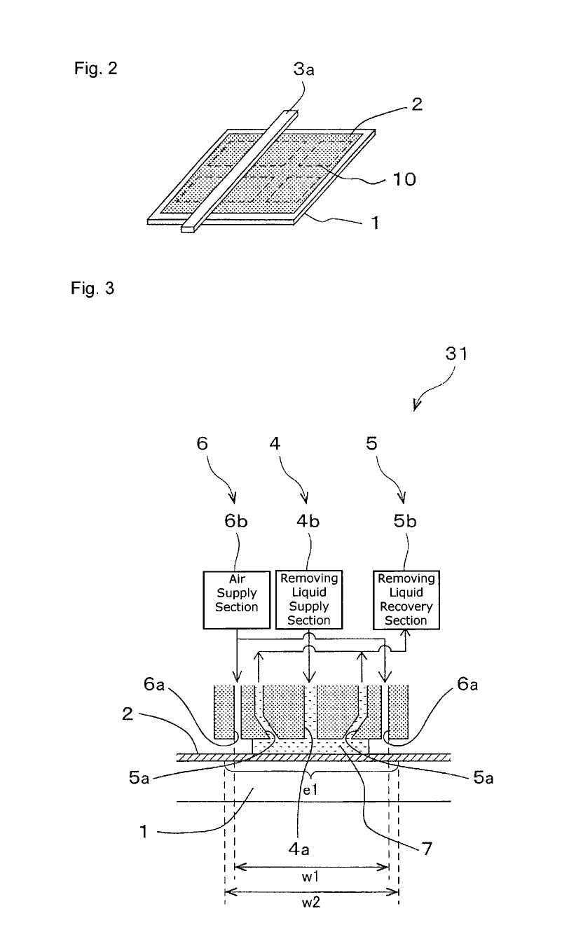

The coating film removal means (longitudinal) 3a is arranged along the up-and-down direction of the stage 9 so as to bridge over the substrate 1 that is adsorbed and held onto the stage 9, while being arranged so as to have a gap of a predetermined value relative to the substrate 1. The coating film removal means (longitudinal) 3a moves in the right-and-left direction, being guided by guides, not shown, which are arranged, for example, on upper and lower sides of the stage 9 along the right-and-left direction. Thus, as shown in FIG. 2, for example, the coating film removal means (longitudinal) 3a is ensured to scan the substrate 1 in the right-and-left direction.

In the present embodiment, the needed film formation regions 10 are arranged in a lattice shape. Accordingly, the coating film removal means (lateral) 3b is arranged being displaced by 90 degrees from the coating film removal means (longitudinal) 3a. In other words, the coating film removal means (lateral) 3b is arranged in the right-and-left direction of the stage 9 so as to bridge over the substrate 1 which is adsorbed and held onto the stage 9, while being arranged so as to have a gap of a predetermined value relative to the substrate 1. The coating film removal means (lateral) 3b moves in the up-and-down direction, being guided by guides, not shown, which are arranged, for example, on right and left sides of the stage 9 along the up-and-down direction. Thus, the coating film removal means (lateral) 3b is ensured to scan the substrate 1 in the up-and-down direction. In other words, the coating film removal means 3a and 3b only have to be movable in two directions by setting, for example, an orthogonal coordinate in arrangement directions of the needed film formation regions 10.

The coating film moving means (longitudinal) 3a and the coating film removal means (lateral) 3b are ensured to be moved by a drive unit, not shown. Further, the coating film moving means (longitudinal) 3a and the coating film removal means (lateral) 3b are each provided with removal treatment units 31 so as to be opposed to the film formation unneeded regions that are the regions other than the needed film formation regions 10 on the substrate 1. Specifically, as shown in FIG. 1(c), the film formation unneeded regions extending in the right-and-left direction of the substrate 1 are e1, e2 and e3 beginning at the top, while the film formation unneeded regions extending in the up-and-down direction of the substrate 1 are e4, e5, e6 and e7 beginning at the left. As shown in FIG. 1(c), the removal treatment units 31 are arranged in the coating film removal means (longitudinal) 3a so as to be located at positions corresponding to the respective film formation unneeded regions e1 to e3. Similarly, the removal treatment units 31 are arranged in the coating film removal means (lateral) 3b so as to be located at positions corresponding to the respective film formation unneeded regions e4 to e7. It should be noted that the removal treatment units 31 all have the same configuration.

FIG. 3 is a cross-sectional view taken along A-A of a removal treatment unit 31 shown in FIG. 1(c).

As shown in FIG. 3, the removal treatment unit 31 includes a removal liquid supply means 4, a removal liquid recovery means 5 and an air supply means 6.

As shown in the cross-sectional view of FIG. 3, the removal liquid supply means 4 includes a removal liquid supply port 4a and a removal liquid supply section 4b that supplies a removal liquid 7 to the removal liquid supply port 4a. When the removal treatment unit 31 is viewed from the top, for example, the removal liquid supply port 4a is arranged in the vicinity of a center portion of the removal treatment unit 31, being opposed to a corresponding film formation unneeded region (e.g., e1 in FIG. 3) on the substrate 1. Upon activation of the removal liquid supply section 4b, the removal liquid 7 for removing coating film is supplied to the removal liquid supply port 4a by the removal liquid supply section 4b, and the removal liquid 7 is discharged from an opening end of the removal liquid supply port 4a on a substrate 1 side onto the substrate 1. The removal liquid supply section 7b is configured such as by a syringe pump that enables quantitative discharge. Thus, a specific quantity of the removal liquid 7 is discharged onto the substrate 1 via the removal liquid supply port 4a.

As shown in the cross-sectional view of FIG. 3, the removal liquid recovery means 5 includes removal liquid recovery ports 5a arranged being opposed to the corresponding film formation unneeded region on the substrate 1, and a removal liquid recovery section 5b. Thus, when the removal treatment unit 31 is viewed from the top, a plurality of removal liquid recovery ports 5a are arranged, for example, surrounding the removal liquid supply port 4a in a square pattern. Further, as shown in FIG. 3, each removal liquid recovery port 5a has an opening end on a side opposed to the substrate 1, the opening end being bent toward the removal liquid supply port 4a. It should be noted that the cross-sectional shape of the removal treatment unit 31, in particular the shapes of the removal liquid supply port 4a and the removing recovery port 5a, and positional relationship therebetween, is not limited to this.

The removal liquid recovery section 5b includes a suction device, such as an ejector tank. Upon activation of the removal liquid recovery section 5b, the removal liquid 7 on the substrate 1 is recovered by the removal liquid recovery section 5b via the removal liquid recovery ports 5a.

As shown in the cross-sectional view of FIG. 3, the air supply means 6 includes an air supply port 6a arranged being opposed to the corresponding film formation unneeded region on the substrate 1, and an air supply section 6b. The air supply port 6a is formed, for example, in a shape squarely surrounding the removal liquid recovery ports 5a. Upon activation of the air supply section 6b, air is ensured to be blown onto the substrate 1. It should be noted that the air supply means 6 corresponds to the “gas supply means” of the present invention, the air supply port 6a corresponds to the “gas supply port” of the present invention, the air supply section 6b corresponds to the “gas supply section” of the present invention, and the air corresponds to the “gas” of the present invention.

As shown in FIG. 3, the air supply port 6a internally has a width w1 along a longitudinal direction of the coating film removal means (longitudinal) 3a, the width w1 being set to be a little smaller than a width w2 of the film formation unneeded region e1, along the longitudinal direction of the coating film removal means (longitudinal) 3a. It should be noted that the length of the air supply port 6a along a shorter-dimension direction of the coating film removal means (longitudinal) 3a is not limited.

When the air supply section 6b is activated, the air blown out of the air supply port 6a plays a role of an air curtain. Thus, the removal liquid 7 discharged from the removal liquid supply port 4a arranged on an inner side of the air supply port 6a is prevented from flying out or flowing out of the film formation unneeded region e1.

The removal treatment units 31 each having such a configuration are arranged in the coating film removal means (longitudinal) 3a, being in conformity with the intervals between the film formation unneeded regions e1, e2 and e3 shown, for example, in FIG. 1(c). Then, in a state where the coating film removal means (longitudinal) 3a is positioned such that the removal treatment units 31 are opposed to the respective film formation unneeded regions e1 to e3, the removal liquid supply means 4, the removal liquid recovery means 5 and the air supply means 6 are activated to ensure discharge of the removal liquid 7 to the film formation unneeded regions and recovery of the removal liquid 7, while the removal liquid is prevented from flowing out of the film formation unneeded regions.

In the case of the coating film removal means (lateral) 3b, the removal treatment units 31 can be arranged in the coating film removal means (lateral) 3b, being in conformity with the intervals between the film formation unneeded regions e4 to e7 shown, for example, in FIG. 1(c).

It should be noted that the removal liquid supply section 4b, the removal liquid recovery section 5b and the air supply section 6b may be provided to the body of the coating film removal means (longitudinal) 3a. Alternatively, the sections 4b, 5b and 6b may be separately provided from the coating film removal means (longitudinal) 3a. In this case, the removal liquid supply section 4b and the removal liquid supply port 4a may be connected to each other via a deformable removal liquid supply tube. Similarly, the removal liquid recovery section 5b and the removal liquid recovery port 5a may be connected to each other via a deformable removal liquid recovery tube. Further, the air supply section 6b and the air supply port 6a may be connected to each other via a deformable air supply tube. Alternatively, not all of the removal liquid supply section 4b, the removal liquid recovery section 5b and the air supply section 6b are required to be provided to the body of the coating film removal means (longitudinal) 3a and the body of the coating film removal means (lateral) 3b. Any one or two of the removal liquid supply section 4b, the removal liquid recovery section 5b and the air supply section 6b may be provided to the coated liquid removal means (longitudinal) 3a and the coating film removal means (lateral) 3b.

Further, the arrangement of the removal liquid supply port 4a, the removal liquid recovery ports 5a and the air supply port 6a in each removal treatment unit 31 is not limited to the above. For example, a plurality of removal liquid supply ports 4a may be provided, and the removal liquid recovery ports 5a may be circularly arranged or may be randomly arranged. The air supply port 6a, although it is formed squarely surrounding the removal liquid supply port 4a and the removal liquid recovery ports 5a, may alternatively be formed circularly surrounding them. Further, two or more air supply ports 6a may be provided. The air supply ports 6a in this case may be arranged at random positions opposed to the vicinity of a boundary in the film formation unneeded regions. The point is that the removal liquid supply port 4a and the removal liquid recovery ports 5a are located in a range enclosed by the air curtain provided by the air supply means 6, and the removal liquid 7 discharged by the removal liquid supply port 4a can be prevented from leaking or moving out of the film formation unneeded regions.

Further, the removal treatment units 31 may be movably arranged in the coating film removal means (longitudinal) 3a and the coating film removal means (lateral) 3b. This arrangement can appropriately cope with the case where the removal treatment is conducted of a plurality of substrates having film formation unneeded regions of different widths and different intervals. In this case, for example, the removal treatment can be appropriately conducted by displacing the positions of the removal treatment units 31, or the removal treatment can be started after adjusting the arrangement positions of the removal treatment units 31 in conformity with the intervals of the film formation unneeded regions.

(Operation and Others)

Following is a description on an operation of the foregoing embodiment.

As shown in FIGS. 1(a)-1(c), the coating film removal means (longitudinal) 3a is arranged, for example, being opposed to the coating film 2 formed on the substrate 1 so as to be close to the coating film 2. The removal liquid 7 is discharged onto the substrate 1 from the removal liquid supply section 4b via the removal liquid supply port 4a such that a specific quantity of the removal liquid 7 is retained between the coated liquid removal means (longitudinal) 3a and the substrate 1 on which the coating film 2 is formed. This state is maintained for a predetermined time. The predetermined time should be sufficient for the coating film 2 to be dissolved or separated by the removal liquid 7.

The substrate 1 and the coating film removal means to (longitudinal) 3a herein are closely arranged, and a specific quantity of the removal liquid 7 is discharged. The gap between the substrate 1 and the coating film removal means (longitudinal) 3a is set, taking account of the characteristics, such as the fluid volume and the viscosity, of the removal liquid, or a discharging speed or the like of the removal liquid 7 caused by the removal liquid supply means 4. Thus, the removal liquid 7 can be retained between the substrate 1 and the coating film removal means (longitudinal) 3a.

When the coating film 2 is dissolved or separated by retention of the removal liquid 7 for a predetermined time, or in other words, after lapse of a time estimated for the coating film 2 to be dissolved or separated, the removal liquid 7 mixed with the coating film 2 between the coating film removal means (longitudinal) 3a and the substrate 1 is recovered and drained by the removal liquid recovery means 5. In other words, the removal liquid recovery section 5b is activated and the removal liquid 7 on the substrate 1 is recovered via the removal liquid recovery ports 5a.

Repeating the supply and recovery of the removal liquid 7, the coating film 2 on the substrate 1 is removed and thus a cleaner substrate surface can be obtained.

In this case, during a period from when the removal liquid 7 is started to be discharged by the removal liquid supply means 4 until when the recovery of the removal liquid 7 on the substrate 1 is completed, the air supply means 6 is activated and the air is discharged onto the substrate 1 via the air supply port 6a. As shown in the cross-sectional view of FIG. 3, the air supply port 6a is arranged around the removal liquid supply port 4a and the removal liquid recovery ports 5a. Accordingly, the air discharged from the air supply port 6a is able to prevent the removal liquid 7 discharged onto the substrate 1 from flying or flowing out of the film formation unneeded regions. Specifically, the coating film 2 in the needed film formation regions 10 is prevented from being unintentionally removed. Thus, only the coating film 2 in the film formation unneeded regions can be removed.

As shown in FIG. 1(a), this operation is performed at individual spots while the coating film removal means (longitudinal) 3a is moved in the right-and-left direction. In this way, removal of the coating film 2 is completed in the film formation unneeded regions extending in the right-and-left direction of the substrate 1 by the coating film removal means (longitudinal) 3a. Subsequently, as shown in FIG. 1(b), the coating film removal means (lateral) 3b is moved in the up-and-down direction. Thus, the coating film 2 in the film formation unneeded regions extending in the up-and-down direction is removed at individual spots in a similar procedure.

In this way, by activating the coating film removal means (longitudinal) 3a and the coating film removal means (lateral) 3b, only the coating film 2 in the film formation unneeded regions of the substrate 1 is removed as shown in FIG. 1(c).

It should be noted that the air supplied by the air supply means 6 may be nitrogen gas or an inert gas (i.e. a gas having low reactivity to an organic material in use), taking account of the influence on the characteristics of the organic material used for the coating film 2. The point is that a gas having low reactivity to an organic material in use may only have to be supplied from the air supply means 6.

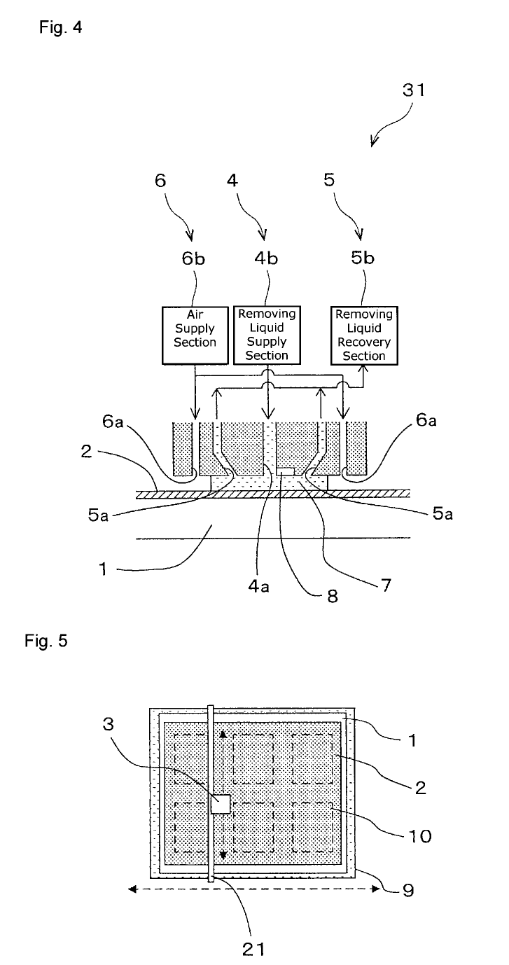

Further, ultrasonic oscillation may be applied to the removal liquid 7 to improve the removability of the coating film 2. Specifically, as shown in FIG. 4, for example, an ultrasonic oscillation application means 8 may be provided to an opening end portion of the removal liquid supply port 4a. Thus, when the ultrasonic oscillation application means 8 is activated, the removal liquid 7 is ensured to be oscillated.

Further, the removal liquid 7 may have a temperature of not less than 30° C. but not more than 40° C. to efficiently dissolve the coating film 2. This can realize reduction of the treatment time and more reliable removal of the coating film 2.

The foregoing embodiment describes the case, as shown in FIGS. 1(a)-1(c), where the coating film removal means (longitudinal) 3a and the coating film removal means (lateral) 3b arranged with an angle of 90 degrees therebetween carry out a scan one at a time to remove the coating film in respect of the entire surface of the substrate 1. However, this should not be construed as imposing a limitation.

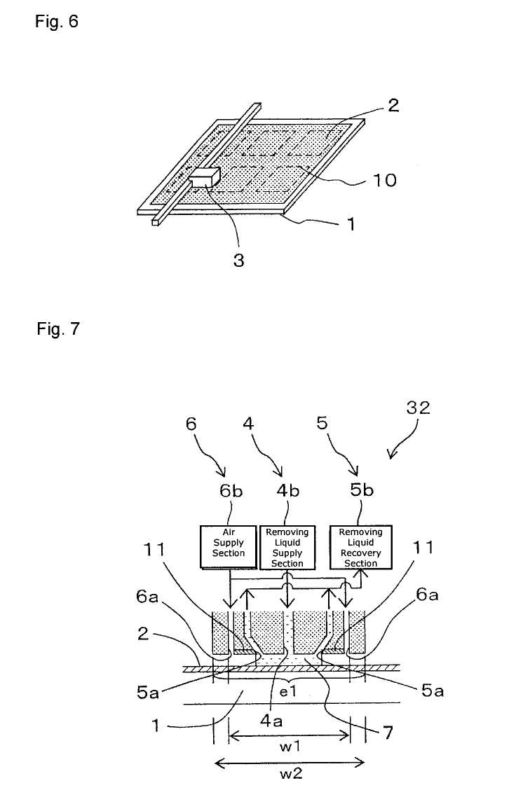

For example, as shown in FIGS. 5 and 6, the coating film removal means 3 may be configured to be movable in the up-and-down direction and the right-and-left direction. For example, as shown in FIG. 5, a guide rail 21 is arranged along the up-and-down direction of the substrate 1 so as to bridge over the substrate 1, and the coating film removal means 3 is movably arranged at the guide rail 21. Further, guides extending in the right-and-left direction are provided along the upper and lower sides of the substrate 1, and the guide rail 21 is arranged so as to be movable in the right-and-left direction, being guided by the guides.

The guide rail 21 is moved in the right-and-left direction, and the coating film removal means 3 is moved in the up-and-down direction on the guide rail 21. Thus, the coating film removal means 3 is moved in the up-and-down direction and the right-and-left direction relative to the substrate 1, that is, the coating liquid 7 is supplied and recovered by the coating film removal means 3 throughout the surface of the substrate 1.

The configurations shown in FIG. 1(a)-1(c) or the configuration shown in FIG. 5 can be selected according to the balance between the time required for the removal of the coating film and the limiting tact or the like.

In the configuration, as shown in FIG. 5, in which the coating film removal means 3 is provided to the guide rail 21, a single removal treatment unit 31 can be provided to the coating film removal means 3. Further, when the coating film 2 is subjected to a removal treatment by a single removal treatment unit 31, in respect of a plurality of film formation unneeded regions, the width w1 of the removal treatment unit 31 is not necessarily appropriate for each film formation unneeded region, such as in the case where the width w1 of the removal treatment unit 31 is considerably smaller than the width of each film formation unneeded region. In this case, in FIG. 6, for example, the coating film removal means 3 can be moved not only in the up-and-down direction but also in the right-and-left direction. The coating film removal means 3 is moved in the up-and-down direction, while fine adjustment is made in the right-and-left direction for the removal of the coating film.

It should be noted that, in the foregoing embodiment, the timing of supplying the removal liquid 7, the timing of recovering the removal liquid 7 and the timing of supplying air by the removal liquid supply means 4, the removal liquid recovery means 5 and the air supply means 6, respectively, can be controlled by a higher-level device, not shown. The higher-level device can also control the coating film removal means (longitudinal) 3a and the coating film removal means (lateral) 3b, as well as the drive unit that drives the coating film removal means (longitudinal) 3a and the coating film removal means (lateral) 3b. Thus, the activation timing of the removal liquid supply means 4, the removal liquid recovery means 5 and the air supply means 6 can be controlled according to the positions of the coating film removal means (longitudinal) 3a and the coating film removal means (lateral) 3b, as well as the coated liquid removal means 3. Accordingly, the coating film 2 in the film formation unneeded regions can be removed with precision.

### Second Embodiment

(Configuration)

As shown in FIGS. 1(a)-1(c), the coating film removing apparatus 101 of the present embodiment has a configuration which is substantially the same as that of the coating film removing apparatus 100 related to the first embodiment, but is different in that the coating film removing apparatus 101 includes removal treatment units 32. More specifically, the coating film removing apparatus 101 is different from the coating film removing apparatus 100 in that the former includes the removal treatment units 32 each of which is obtained by providing a water-repellent outer cover 11 to the removal treatment unit 31 related to the first embodiment. In other words, the coating film removing apparatus 101 is a coating film removing apparatus in which the removal treatment units 31 related to the coating film removing apparatus 100 are replaced by the removal treatment units 32. Accordingly, the following description is focused on only the water-repellent outer cover 11 and description on the rest of the components is omitted.

FIG. 7 is a cross-sectional view of a removal treatment unit related to the second embodiment of the present invention, the cross-sectional view being taken along A-A of FIG. 1(c). As shown in FIG. 7, the removal treatment unit 32 is obtained by providing the water-repellent outer cover 11 to the removal treatment unit 31 related to the first embodiment. The water-repellent outer cover 11 is in a shape of squarely surrounding the removal liquid supply port 4a and the removal liquid recovery ports 5a. Being formed into this shape, it is ensured that the removal liquid 7 discharged from the removal liquid supply port 4a arranged inside the water-repellent outer cover 11 is suppressed from wetly expanding outside. In other words, the water-repellent outer cover 11 is formed, surrounding the removal liquid supply port 4a and the removal liquid recovery ports 5a.

It should be noted that, in the removal treatment unit 32, the water-repellent outer cover 11 may be arranged, as mentioned above, squarely surrounding the removal liquid supply port 4a and the removal liquid recovery ports 5a, or may, for example, be arranged circularly surrounding them. Further, the water-repellent outer cover 11 may be randomly arranged at a position opposed to the vicinity of a boundary in the film formation unneeded regions. The point is that the removal liquid supply port 4a and the removal liquid recovery ports 5a are located in a range enclosed by the water-repellent outer cover 11, and the water repellency of the water-repellent outer cover 11 can suppress the removal liquid 7 discharged from the removal liquid supply port 4a from moving out of the film formation unneeded regions. It should be noted that the water-repellent outer cover 11 preferably has a water contact angle of not less than 90 degrees.

Further, in the removal treatment unit 32, the air supply port 6a may be arranged, for example, squarely surrounding the removal liquid supply port 4a, the removal liquid recovery ports 5a and the water-repellent outer cover 11, or may be arranged circularly surrounding them. Further, two or more air supply ports 6a may be provided. The air supply ports 6a in this case may be arranged at random at positions opposed to the vicinity of a boundary in the film formation unneeded regions. The point is that the removal liquid supply port 4a, the removal liquid recovery ports 5a and the water-repellent outer cover 11 are located in a range enclosed by the air curtain provided by the air supply means 6, and the removal liquid 7 discharged by the removal liquid supply port 4a can be prevented from flying or moving out of the film formation unneeded regions.

As described above, according to the coating film removing apparatus 101 including the removal treatment unit 32, the water-repellent outer cover 11 applied with water-repellent treatment is arranged around the removal liquid supply port 4a and the removal liquid recovery ports 5a. Accordingly, the removal liquid 7 discharged onto the substrate 1 can be suppressed from wetly expanding out of the film formation unneeded regions, owing to the water repellency of the water-repellent outer cover 11.

Further, according to the coating film removing apparatus 101, the air supply port 6a is arranged around the removal liquid supply port 4a and the removal liquid recovery ports 5a. Accordingly, the air discharged from the air supply port 6a is able to prevent the removal liquid 7 discharged onto the substrate 1 from flying or flowing out of the film formation unneeded regions.

In this way, together with the effect of suppressing the wet expansion of the removal liquid 7 by the water-repellent outer cover 11, the coating film removing apparatus 101 is able to prevent the coating film 2 in the needed film formation regions 10 from being unintentionally removed. Thus, only the coating film 2 in the film formation unneeded regions can be more reliably removed.

(Operation and Others)

The operation and others of the coating film removing apparatus 101 related to the present invention are the same as those of the coating film removing apparatus 100 related to the first embodiment. Specifically, the matters described on the operation and others of the coating film removing apparatus 100 can be directly applied to the operation and others of the coating film removing apparatus 101. Therefore, the details of the operation and others of the coating film removing apparatus 101 are omitted.

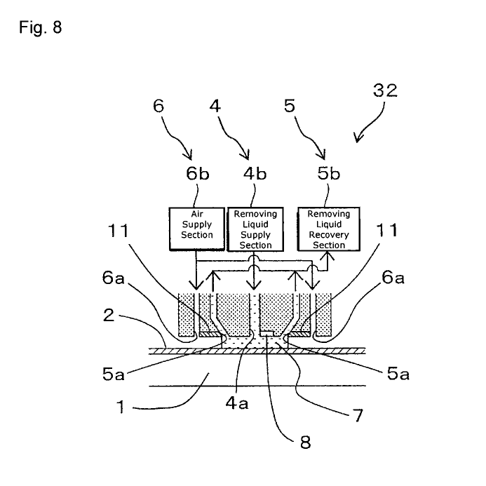

It should be noted that, in the present embodiment, ultrasonic oscillation may be applied to the discharged removal liquid 7 to improve removability of the coating film 2, similar to the first embodiment. Specifically, as shown in FIG. 8, for example, the ultrasonic oscillation application means 8 may be provided to an opening end portion of the removal liquid supply port 4a. Activating the ultrasonic oscillation application means 8, the removal liquid 7 can be oscillated.

### EXAMPLES <Organic EL Display>

### Example 1

Removal of a coating film using the coating film removing apparatus 100 and 101 related to the embodiments of the present invention is described by way of an example. The example is a process for forming a film of a hole transport layer of an organic EL display. The process includes coating an organic material, which forms the hole transport layer, onto a substrate by means of a slit die, and removing unneeded coating film at the perimeter of a light-emitting region which is the needed film formation region.

As a hole transport layer material for coating, poly(3,4)ethylenedioxythiophene/polystyrene sulfonate (PEDOT/PSS) was used and, as a removal liquid, pure water was used.

As a substrate, alkalifree glass OA-10 (manufactured by Asahi Glass Co., Ltd.) 120 mm×120 mm×0.7 mm was used. With the needed film formation region being 50 mm×50 mm, it was attempted to selectively remove the unneeded coating film outside the four-sided perimeter.

First, the hole transport material was coated onto the cleaned substrate by means of a slit die so as to cover a range of 100 mm×100 mm, followed by drying at 180° C. for one hour under a vacuum drying condition, thereby obtaining a coating film of 100 nm thickness.

An area of 50 mm×50 mm situated near the center of the coating range of the hole transport material was assumed to be the needed film formation region. The outer side of the four-sided perimeter is selectively removed from the coating film by means of the coating film removal means 3 having the removal liquid supply means 4 and the removal liquid recovery means 5 as shown in FIG. 3 or 4. A gap between the substrate and a lower end of the coating film removal means 3 was rendered to be 1 mm. A syringe pump was used as the removal liquid supply section 4b of the removal liquid supply means 4 to enable quantitative discharge, thereby regulating the quantity of the removal liquid retained in the gap between the substrate and the coating film removal means 3.

Further, the removal liquid recovery means 5 evacuated and recovered the removal liquid that was retained between the substrate and the coating film removal means 3 for a desired duration of time to dissolve the hole transport material. It was confirmed that a retaining time of not less than 30 seconds could mostly remove the coating film. However, one more repetition of the similar operation can reliably remove the material that has remained without being completely recovered and thus a higher cleaning level can be expected.

Scan was repeatedly carried out by the coating film removal means 3. Further, the scanning direction was changed by 90 degrees, followed by sequentially treating the unneeded coating film in the film formation unneeded region outside the four-sided perimeter of the needed film formation region. This could create a state where there was no residual coating film at the perimeter of the 50 mm×50 mm needed film formation region. Further, it was confirmed that a desired state was created by the supply of air, in the coating film removal means 3, from the air supply port 6a arranged outside the removal liquid supply port 4a and the removal liquid recovery ports 5a, without allowing the removal liquid to splash into the needed film formation region.

When the coating film removing apparatus 101 (i.e. the coating film removing apparatus including the removal treatment units 32 each having the water-repellent outer cover 11) related to the second embodiment was used, wet expansion of the removal liquid into the needed film formation region was confirmed to be suppressed, owing to the water repellency of the water-repellent outer cover 11 arranged outside the removal liquid supply port 4a and the removal liquid recovery ports 5a in the coating film removal means 3. It should be noted that water repellency with a water contact angle of 90 degrees was obtained by applying a nickel-Teflon (trademark) plating treatment to a surface of the water-repellent outer cover 11, the surface being opposed to the coating film. The “nickel-Teflon (trademark) plating treatment” refers to having Teflon (trademark) compounded into a nickel-plated coating.

### Example 2

In the conditions of Example 1, the temperature condition of the removal liquid was 24° C. In contrast, the temperature condition of the removal liquid was changed from 24° C. to 30° C. to similarly remove a coating film. It should be noted that other conditions than the temperature condition were the same as those of Example 1.

As a result, in contrast to the temperature 24° C. of the removal liquid which could remove the coating film in about 30 seconds, it was confirmed that the temperature 30° C. of the removal liquid could shorten the time required for removing the coating film to about 20 seconds and the removal performance was improved. When the temperature of the removal liquid was further raised, the removal performance was confirmed to be more improved. However, there was no large difference in the improvement of the removal performance at the temperatures higher than 40° C., and the exerted effect was smaller, while there was a concern of having an influence from the vapor. From this point of view, the temperature condition is required to be adopted, considering the apparatus and the materials.

### Example 3

Subsequently, under the conditions of Example 2, i.e. under the conditions including the temperature condition of the removal liquid as being 30° C., the coating film was removed by the coating film removal means 3, with the application of ultrasonic oscillation to the removal liquid by means of an ultrasonic oscillator as the ultrasonic oscillation application means 8. It should be noted that the output of the ultrasonic oscillation was about 50 to 300 W and the oscillation frequency was about 30 to 100 kHz.

As a result, in contrast to the removal of the coating film in about 20 seconds in the absence of the ultrasonic oscillation, it was confirmed that the application of the ultrasonic oscillation could shorten the time required for removing the coating film to about 15 seconds and the removal performance was improved.

Thus, whichever of the coating film removing apparatus 100 and 101 may be used, the coating film at the perimeter portion of an organic light-emitting pixel can be reliably removed. Accordingly, a polymer organic EL panel can be produced by adopting a coating method of easy and uniform film formation in the formation of a common layer, such as a hole transport layer or a hole injection layer, which does not require color-coding on a pixel basis.

<Color Filter for Liquid Crystal Display>

### Example 4

Removal of a coating film using the coating film removing apparatus 100 and 101 is described by way of another example. The example is a process for forming a film of a photosensitive resin layer of a color filter for a liquid crystal display. The process includes coating an organic material, which forms the photosensitive resin layer, onto a substrate by means of a slit die, and, with the needed film formation region being assumed to be a pixel region, removing the unneeded coating film at the perimeter of the pixel region.

As the photosensitive resin material to be coated, OFPR-800 manufactured by Tokyo Ohka Kogyo, Co. Ltd. was used and, as the removal liquid, a 1.0 wt % sodium carbonate solution at 30° C. was used.

As a substrate, alkali-free glass OA-10 (manufactured by Asahi Glass Co., Ltd.) 120 mm×120 mm×0.7 mm was used. With the needed film formation region as being 50 mm×50 mm, the unneeded coating film outside the four-sided perimeter was attempted to be selectively removed.

First, the photosensitive resin material was coated on the cleaned substrate by means of a slit die so as to cover a range of 100 mm×100 mm, followed by drying under vacuum dried condition of 1 Torr, thereby obtaining a coating film of 1.5 μm.

A range of 50 mm×50 mm situated nearer the center of the coating range of the photosensitive material was assumed to be the needed film formation region. Selective removal of the coating film was conducted of the outer side of the four-sided perimeter by means of the coating film removal means 3 having the removal liquid supply means 4 and the removal liquid recovery means 5 as shown in FIG. 3 or 4. A gap between the substrate and a lower end of the coating film removal means 3 was rendered to be 1 mm. A syringe pump was used as the removal liquid supply section 4b of the removal liquid supply means 4 to enable quantitative discharge, thereby regulating the quantity of the removal liquid retained in the gap between the substrate and the coating film removal means 3.

Further, the removal liquid recovery means 5 evacuated and recovered the removal liquid that was retained between the substrate and the coating film removal means 3 for a desired duration of time to dissolve the photosensitive resin material. It was confirmed that retaining time of not less than 30 seconds could mostly remove the coating film. However, one more repetition of the similar operation can reliably remove the material that has remained without being completely recovered and thus a higher cleaning level can be expected.

Scan was repeatedly carried out by the coating film removal means 3. Further, the scanning direction was changed by 90 degrees, followed by sequentially treating the unneeded coating film in the film formation unneeded region outside the four-sided perimeter of the needed film formation region. This could create a state where there was no residual coating film at the perimeter of the needed film formation region of 50 mm×50 mm. Further, it was confirmed that a desired state was created by the supply of air, in the coating film removal means 3, from the air supply port 6a arranged outside the removal liquid supply port 4a and the removal liquid recovery ports 5a, without allowing the removal liquid to fly into the needed film formation region.

When the coating film removing apparatus 101 related to the second embodiment was used, wet expansion of the removal liquid into the needed film formation region was confirmed to be suppressed, owing to the water repellency of the water-repellent outer cover 11 arranged at the coating film removal means 3. It should be noted that water repellency with a water contact angle of 90 degrees was obtained by applying nickel-Teflon (trademark) plating treatment to a surface of the water-repellent outer cover 11, the surface being opposed to the coating film.

Some embodiments of the present invention have so far been described. However, the present invention should not be construed as being limited to the foregoing embodiments. In the foregoing embodiments, an organic EL display and a color filter for a liquid crystal display have been described. However, the present invention should not be construed as being limited to these, but may be applied to a film formation substrate for different usages. Further, the coating film should not be limited to the materials for organic EL usage, including a hole transport layer, or photosensitive resin materials, but may be applied to other functional materials required for the usage. Further, the removal liquid can be appropriately selected according to the material of the coating film, and thus an organic solvent or the like can be the removal liquid.

A printing method is desired to have a much better coating method from a viewpoint of easiness and uniformity in film formation.

Further, in the method of immersing a portion, where a film is coated, into a reservoir of a solvent, the portions to which the method can be applied are limited, such as to the end portions of a substrate. Therefore, it has been desired to provide a method that enables removal of a film in any portion.

In this regard, the present invention has as its object to provide a coating film removing apparatus which is able to easily and precisely remove a coating film that is coated in a film formation unneeded region, in a manufacturing process such as of a polymer organic EL panel.

An aspect of the present invention is a coating film removing apparatus including: a removal liquid supply means (e.g., the removal liquid supply means 4 shown in FIG. 3) for discharging a removal liquid for removing a coating film, targeting only a coating film removal portion that is a part of the coating film on a substrate (e.g., the substrate 1 shown in FIGS. 1(a)-1(c)); and a removal liquid recovery means (e.g., the removal liquid recovery means 5 shown in FIG. 3) for recovering the removal liquid, characterized in that: a predetermined quantity of removal liquid is discharged from the removal liquid supply means targeting only the coating film removal portion, in a state where a discharge port for the removal liquid, which is a part of the removal liquid supply means, and a recovery port for the removal liquid, which is a part of the removal liquid recovery means are permitted to face the coating film removal portion; and the removal liquid is thereafter recovered by the removal liquid recovery means.

The coating film removing means may include a water-repellent outer cover (e.g., the water-repellent outer cover 11 shown in FIG. 7) applied with water-repellent treatment to encompass the discharge port and the recovery port.

The water-repellent outer cover may have a water contact angle of not less than 90 degrees.

The coating film removing apparatus may allow the removal liquid recovery means to recover the removal liquid, after lapse of a preset retention time from discharge of the removal liquid targeting only the coating film removal portion.

The coating film removing apparatus may include an ultrasonic oscillation application means (e.g., the ultrasonic oscillation application means 8 shown in FIG. 4) for applying ultrasonic oscillation to the removal liquid discharged targeting the coating film removal portion.

Temperature of the removal liquid discharged targeting the coating film removal portion may be not less than 30° C. but not more than 40° C.

The coating film removing apparatus may further include a gas supply means (e.g., the air supply means 6 shown in FIG. 3) for discharging a gas toward any position on the substrate; and a gas may be ensured to be discharged from the gas supply means to prevent the removal liquid from flowing out of the coating film removal portion, during a period from start of discharge of the removal liquid by the removal liquid supply means targeting the coating film removal portion until completion of recovery of the removal liquid by the removal liquid recovery means.

The gas supply means may be arranged surrounding the water-repellent outer cover.

The gas supply means may discharge nitrogen gas as the gas.

The coating film removing apparatus may horizontally move the removal liquid supply means and the removal liquid recovery means to a position of facing the coated liquid removal portion to discharge and recover the removal liquid.

Another aspect of the present invention is a coating film removing apparatus including: a removal liquid supply means (e.g., the removal liquid supply means 4 shown in FIG. 3) for discharging a removal liquid for removing a coating film, targeting only a coating film removal portion that is a part of the coating film on a substrate (e.g., the substrate 1 shown in FIG. 3); a removal liquid recovery means (e.g., the removal liquid recovery means 5 shown in FIG. 3) for recovering the removal liquid after lapse of a predetermined time from discharge of the removal liquid by the removal liquid supply means targeting the coating film removal portion; a gas supply means (e.g., the air supply means 6 shown in FIG. 3) for discharging a gas to prevent the removal liquid from flowing out of the coating film removal portion, during a period from start of discharge of the removal liquid by the removal liquid supply means until completion of recovery of the removal liquid by the removal liquid recovery means, and a horizontal movement section (e.g., the coating film removal means (longitudinal) 3a or the coating film removal means (lateral) 3b shown in FIGS. 1(a)-1(c)) having a discharge port for the removal liquid, which is a part of the removal liquid supply means, a recovery port for the removal liquid, which is a part of the removal liquid recovery means, and a discharge port for the gas, which is a part of the gas supply means, the horizontal movement section being made horizontally movable, characterized in that: the discharge port for the gas is arranged enclosing the discharge port for the removal liquid and the recovery port for the removal liquid.

The coating film removing apparatus may further include a water-repellent outer cover that is arranged outside the discharge port for the removal liquid and the recovery port for the removal liquid to suppress the removal liquid from spreading out of the coating film removal portion; and the discharge port for the gas may be arranged further enclosing the water-repellent outer cover.

### ADVANTAGEOUS EFFECTS OF THE INVENTION

According to an aspect of the present invention, the coating film removal portion that is a part of the coating film on the substrate can be easily and precisely removed. Accordingly, for example, the coating film at the perimeter portion or the like of an organic light-emitting pixel can be reliably removed. As a result, a polymer organic EL panel can be easily obtained, with its sealing effect being improved and with defects being eliminated from the light-emitting pixels.

### DESCRIPTION OF REFERENCE NUMERALS

1 . . . Substrate
2 . . . Coating film
3 . . . Coating film removal means
3a . . . Coating film removal means (longitudinal)
3b . . . Coating film removal means (lateral)
4 . . . Removal liquid supply means
5 . . . Removal liquid recovery means
6 . . . Air supply means
7 . . . Removal liquid
8 . . . Ultrasonic oscillation application means
9 . . . Stage
10 . . . Needed film formation region
11 . . . Water-repellent outer cover
31 . . . Removal treatment unit
32 . . . Removal treatment unit
e1 to e7 . . . Film formation unneeded region
100 . . . Coating film removing apparatus
101 . . . Coating film removing apparatus

Obviously, numerous modifications and variations of the present invention are possible in light of the above teachings. It is therefore to be understood that within the scope of the appended claims, the invention may be practiced otherwise than as specifically described herein.

What is claimed is:

1. A coating film removing apparatus, comprising:
a removal liquid supply device having a discharge port and configured to discharge removal liquid through the discharge port such that the removal liquid for removing a coating film on a substrate is discharged only to a coating film removal portion of the coating film; and
a removal liquid recovery device having a recovery port and configured to recover the removal liquid through the recovery port,
wherein the removal liquid supply device is configured to discharge a predetermined quantity of the removal liquid to the coating film removal portion in a state where the discharge port and the recovery port are positioned to face the coating film removal portion such that the removal liquid discharged through the discharge port is recovered through the recovery port.

2. The coating film removing apparatus according to claim 1, further comprising:
a water-repellent outer cover formed outside the discharge port and the recovery port.

3. The coating film removing apparatus according to claim 2, wherein the water-repellent outer cover has a water contact angle of not less than 90 degrees.

4. The coating film removing apparatus according to claim 1, wherein the removal liquid recovery device is configured to recover the removal liquid after lapse of a preset retention time from discharge of the removal liquid to the coating film removal portion.

5. The coating film removing apparatus according to claim 1, further comprising:
an ultrasonic oscillation application device configured to apply ultrasonic oscillation to the removal liquid discharged to the coating film removal portion.

6. The coating film removing apparatus according to claim 2, further comprising:
an ultrasonic oscillation application device configured to apply ultrasonic oscillation to the removal liquid discharged to the coating film removal portion.

7. The coating film removing apparatus according to claim 3, further comprising:
an ultrasonic oscillation application device configured to apply ultrasonic oscillation to the removal liquid discharged to the coating film removal portion.

8. The coating film removing apparatus according to claim 1, wherein the removal liquid discharged to the coating film removal portion has a temperature of not less than 30° C. but not more than 40° C.

9. The coating film removing apparatus according to claim 1, further comprising:
a gas supply device configured to discharge a gas toward a position on the substrate,
wherein the gas supply device is configured to discharge the gas such that the removal liquid remains in the coating film removal portion during a period from start of discharge of the removal liquid by the removal liquid supply device until completion of recovery of the removal liquid by the removal liquid recovery device.

10. The coating film removing apparatus according to claim 9, wherein the gas supply device is positioned outside the water-repellent outer cover.

11. The coating film removing apparatus according to claim 9, wherein the gas supply device is configured to discharge nitrogen gas.

12. The coating film removing apparatus according to claim 2, further comprising:
a gas supply device configured to discharge a gas toward a position on the substrate,
wherein the gas supply device is configured to discharge the gas such that the removal liquid remains in the coating film removal portion during a period from start of discharge of the removal liquid by the removal liquid supply device until completion of recovery of the removal liquid by the removal liquid recovery device.

13. The coating film removing apparatus according to claim 12, wherein the gas supply device is positioned outside the water-repellent outer cover.

14. The coating film removing apparatus according to claim 7, further comprising:
a gas supply device configured to discharge a gas toward a position on the substrate,
wherein the gas supply device is configured to discharge the gas such that the removal liquid remains in the coating film removal portion during a period from start of discharge of the removal liquid by the removal liquid supply device until completion of recovery of the removal liquid by the removal liquid recovery device.

15. The coating film removing apparatus according to claim 14, wherein the gas supply device is positioned outside the water-repellent outer cover.

16. The coating film removing apparatus according to claim 1, wherein the removal liquid supply device and the removal liquid recovery device are horizontally movable to a position facing the coated liquid removal portion to discharge and recover the removal liquid, respectively.

17. The coating film removing apparatus according to claim 3, wherein the removal liquid supply device and the removal liquid recovery device are horizontally movable to a position facing the coated liquid removal portion to discharge and recover the removal liquid, respectively.

18. The coating film removing apparatus according to claim 15, wherein the removal liquid supply device and the removal liquid recovery device are horizontally movable to a position facing the coated liquid removal portion to discharge and recover the removal liquid, respectively.

19. A coating film removing apparatus, comprising:
a removal liquid supply device having a discharge port and configured to discharge removal liquid through the discharge port such that the removal liquid for removing a coating film on a substrate is discharged only to a coating film removal portion of the coating film;
a removal liquid recovery device having a recovery port and configured to recover the removal liquid through the recovery port after lapse of a predetermined time from discharge of the removal liquid by the removal liquid supply device; and
a gas supply device having a gas discharge port and configured to discharge a gas through the gas discharge port such that the removal liquid remains in the coating film removal portion during a period from start of discharge of the removal liquid by the removal liquid supply device until completion of recovery of the removal liquid by the removal liquid recovery device,
wherein the gas discharge port is formed outside the discharge and recovery ports for the removal liquid, and
the discharge and recovery ports for the removal liquid and the gas discharge port are formed in a horizontal movement section which is horizontally movable.

20. The coating film removing apparatus according to claim 19, further comprising:
a water-repellent outer cover formed outside the discharge port and the recovery port,
wherein the gas discharge port is positioned outside the water-repellent outer cover.
